(19) United States
(12) Patent Application Publication
(10) Pub. No.: US 2008/0274252 A1
(43) Pub. Date: Nov. 6, 2008

(54) Pullulan film containing sweetener

(76) Inventors: Andrew J. Hoffman, Mount Zion, IL (US); Shiji Shen, Forsyth, IL (US); Michael D. Harrison, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/098,525

(22) Filed: Apr. 7, 2008

Related U.S. Application Data
(60) Provisional application No. 60/911,367, filed on Apr. 12, 2007.

(51) Int. Cl. A23L 1/236; B65D 85/72

(52) U.S. Cl. 426/548; 426/658; 221/45; 221/100; 206/555

(57) ABSTRACT

An edible film comprises a major amount of pullulan and at least one sweetener in an amount of at least about 10% by weight on a dry solids basis. The sweetener can be, for example, a high intensity sweetener such as sucralose, aspartame, acesulfame K, brazzein, and combinations of two or more thereof. The edible film can be used in a sweetener dispenser that comprises a container and a plurality of film strips. The container has an inner compartment and an aperture that is adapted to be opened. The plurality of film strips are located in the inner compartment. Individual film strips can be removed from the container through the aperture.

This application claims priority from U.S. provisional patent application Ser. No. 60/911,367, filed on Apr. 12, 2007, which is incorporated herein by reference.

### BACKGROUND OF THE INVENTION

Edible films have been made from film-forming polymers such as pullulan. For example, edible strips containing pullulan and a breath-freshening agent have been sold for human consumption. Cough suppressants, vitamins, and dietary supplements have also been supplied in the form of edible strips.

Sweeteners such as sucrose (table sugar), sucralose, and aspartame are well known. It is also known to provide individual serving-sized packages of granular sweeteners, such as those commonly available in restaurants. However, even these individual-serving sizes can be inconvenient for a user to carry throughout the day. Therefore, there is a need for improved ways of providing sweeteners for everyday use.

### SUMMARY OF THE INVENTION

One aspect of the present invention is an edible film that comprises a major amount of pullulan and at least one sweetener in an amount of at least about 10% by weight on a dry solids basis. “A major amount” means that the film comprises a greater quantity of pullulan than of any other ingredient.

In some embodiments of the invention, the at least one sweetener is a high intensity sweetener. Suitable examples include sucralose, aspartame, acesulfame K, brazzein, and combinations of two or more thereof.

Another aspect of the invention is a sweetener dispenser. The dispenser comprises a container and a plurality of film strips. The container has an inner compartment and an aperture that is adapted to be opened. The film strips comprise the ingredients described above and are located in the inner compartment. Individual film strips can be removed from the container through the aperture.

Another aspect of the invention is a method for sweetening a food (defined herein to include beverages). The method comprises providing a sweetener dispenser as described above, removing at least one film strip from the dispenser, and placing the at least one film strip in or on a food.

### BRIEF DESCRIPTION OF DRAWING

FIG. 1 is a perspective view of a sweetener dispenser according to one embodiment of the invention.

### DESCRIPTION OF SPECIFIC EMBODIMENTS

An edible film of the present invention can comprise a major amount of pullulan and at least one sweetener in an amount of at least about 10% by weight on a dry solids basis (dsb). As explained above, “a major amount” means that the film comprises a greater quantity of pullulan than of any other ingredient. In many embodiments of the invention, the film is water soluble, but it should be understood that embodiments in which the film does not entirely dissolve in water, or dissolves in water relatively slowly, are not excluded.

In some embodiments, pullulan makes up greater than 50% by weight of film on a dry solids basis, or in some cases, greater than 75 wt % dsb. In some embodiments, pullulan makes up about 35-80 wt % dsb of the film. The film can optionally also include one or more film forming polymers other than pullulan. For example, the film can also contain polymers such as pectin, alginates, carrageenans, xanthan gum, modified cellulose, polydextrose, starch or a starch derivative (such as dextrin or maltodextrin), and combinations of two or more such materials. In some situations, inclusion of one or more of these polymers can enhance film strength and solubility and reduce cost as compared to compositions that contain only pullulan as a film-forming ingredient.

A variety of sweeteners can be used in the film. In some embodiments, the film contains at least about 10 wt % dsb sweetener but no more than about 25 wt % dsb. In one embodiment, the sweetener content of the film is about 15 wt % dsb. In one embodiment, the sweetener is a high intensity sweetener, such as, for example, sucralose, aspartame, acesulfame K (“ace-K”), brazzein, or a combinations of two or more such sweeteners. In one embodiment, the at least one sweetener consists essentially of sucralose. The high degree of sweetening provided by sucralose per unit mass makes it well suited for use in the present invention.

In one embodiment of the invention, the film is cut into individual film strips, and the amount of high intensity sweetener that is present in the film is selected to provide approximately the same sweetening effect as a selected quantity of sucrose. For example, sucralose is approximately 600 times sweeter than sucrose on a weight basis. Therefore, the amount of sucralose in the film strip can be 600 times less than the amount of sucrose that would be needed to provide the desired sweetening. As a specific example, a film strip that contains about 6-7 mg of sucralose will provide about the same sweetening as 1 teaspoon (about 4 g) of sucrose. The same type of calculation can be performed for other sweeteners, such as those shown in the following table:

| | Sweetening compared to |
|---|---|
| High Intensity Sweetener | sucrose (wt basis) |
| aspartame | 180x |
| acesulfame K | 200x |
| brazzein | 1500x |

Optionally, the film can also contain at least one plasticizer, for example in an amount sufficient to prevent the film from being brittle. In some embodiments, the concentration of plasticizer in the film can be about 1-30 wt % dsb. A plasticizer concentration of about 10 wt % dsb has been found to work well in some embodiments. Suitable plasticizers include, but are not limited to glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations of any of these materials.

Optionally, the composition can also comprise at least one salt. In at least some embodiments, the addition of salt to the film improves its elongation. Typically, in order to improve elongation, surface properties are sacrificed such as blocking and tackiness. However, when salt is included in the composition to increase elongation, surface properties in many instances are improved. Films that contain salt and a suitable level of plasticizer do not block and are not tacky, and therefore can be rolled onto themselves more easily. The addition of salt to the film can also improve its solubility and dissolution rate. Examples of suitable salts include sodium chloride, potassium chloride and magnesium chloride. In certain embodiments of the invention, the concentration of salt in the film-forming composition is about 0.3-15% by weight on a dry solids basis.

As another option, the film-forming composition can comprise at least one internal film release agent, to make it easier to peel the film from a substrate surface on which it is cast. Suitable examples of internal film release agents include, but are not limited to, polyoxyethylene sorbitan monooleate, sodium lauryl sulfate, and combinations thereof. Polyoxyethylene (20) sorbitan monooleate is commercially available as Polysorbate 80.

The film optionally can also contain gelatin. The use of gelatin as a secondary polymer can maintain or improve elongation while maintaining film strength. Gelatin can also give the film a smooth surface without increased tackiness and blocking. In certain embodiments, the gelatin concentration can be about 0.5-22.5 wt % dsb.

The film optionally can also contain a food grade wax, for example in the form of an emulsion. The film can contain, in some embodiments, about 0.1-10 wt % dsb wax, but a wax content of less than about 5% is usually preferred. Suitable waxes include carnauba, candelilla, and beeswax. The presence of wax can improve the anti-blocking and flexibility of the film.

The film optionally can also contain one or more additives that are suitable for use in foods, such as colorants, flavors, fillers, surfactants, stabilizers, and organic acids (such as citric acid). The film is free of pharmaceuticals and preferably is free of volatile or non-volatile cooling agents such as menthol or menthyl esters. The film can be used by itself, rather than being used as a coating on a distinct object, such as a pill or tablet that contains an active ingredient.

Techniques of forming films using pullulan compositions are well known in the art. For example, an aqueous pullulan composition (e.g., about 20% solids) can be cast onto a flat surface, and then heated and dried to form the film. The film can be prepared in any desired thickness. In some embodiments of the invention, the film will have a thickness between about 0.002 inches and about 0.02 inches. Methods for controlling the thickness of the film are also well known.

Some film compositions that are cast directly onto a stainless steel substrate do not release well from the steel. These films will often simply stretch out and become distorted when one attempts to remove them from untreated steel. In order to eliminate or reduce this problem, the steel substrate optionally can be treated with solutions or suspensions that comprise release agents.

The coating of the substrate with the solution or suspension of a food grade surfactant (i.e., an external film release agent) makes it easier to peel the film away from the substrate. Suitable surfactants for this purpose include, but are not limited to, propylene glycol monostearate, sodium stearoyl lactylate, polyoxyethylene sorbitan monooleate (e.g., Polysorbate 80), sodium lauryl sulfate, salts of stearic acid, or a combination thereof. Suitable surfactants can be used in quantities up to 10% by weight in solutions of water and/or alcohol (e.g., isopropyl alcohol), or other suitable solvent systems.

Films of the present invention can be cut into any desired shape and size, such as rectangular strips, which makes it easy to store and use them. They can take up less space in a restaurant or home pantry than a conventional sweetener packages, and can be portable for on-the-go uses.

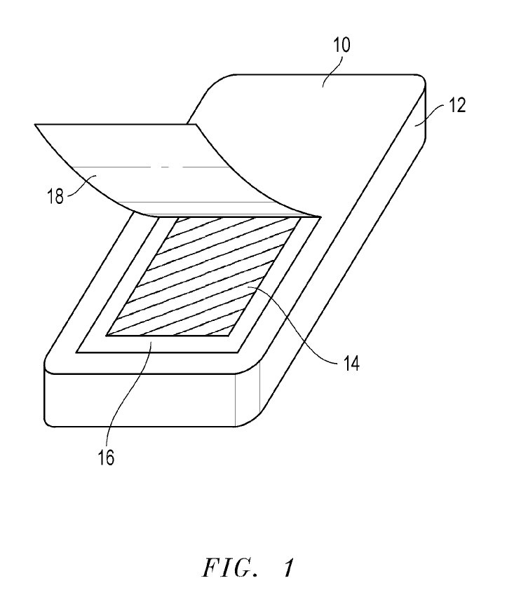

Film strips as described above can be stored in a variety of container types. In one embodiment, shown in FIG. 1, the container can be a sweetener dispenser 10 that comprises a container 12 and a plurality of film strips 14. The container has an inner compartment and an aperture 16 that is adapted to be opened. The film strips are located in the inner compartment. Individual film strips can be removed from the container through the aperture. Such a dispenser can be referred to as a cassette, similar to those used to dispense breath-freshening strips, in which the aperture is opened and closed by a small hinged plastic door 18, for example. The sweetener dispenser can have a small size, so that it can be carried in a clothing pocket or purse. Although the film strips can have a wide variety of sizes and shapes, rectangular strips that each weight about 30-50 mg are well-suited for use in a dispenser as described herein. In one particular embodiment, the film strip is about 50 μm thick, 22 mm wide, and 30 mm long, and weighs about 42 mg.

Another aspect of the invention is a method for sweetening a food using one or more of the above-described film strips. (“Food” is used herein in a broad sense to include beverages.) The method comprises providing a sweetener dispenser as described above, removing at least one film strip from the dispenser, and placing the at least one film strip in or on a food. For example, a person in a restaurant could carry a sweetener dispenser in a clothing pocket or purse, and remove one or more film strips from dispenser to use in sweetening a beverage. After one or more of the film strips are placed in the beverage, the strips dissolve and sweeten the beverage.

As another example, a person could use the above-described film in cooking. Instead of adding a measured quantity of sucrose or another particulate sweetener to the food preparation, one or more film strips of the present invention could be added instead. Because the amount of sweetener in each film strip would be known by the user, measurement errors and spillage could be reduced or eliminated.

The film strips could be used in a wide variety of foods and cooking methods. For example, the film can be used in sauteing, stir frying, pan frying, grilling, broiling, roasting, steaming, simmering, braising, and stewing.

### EXAMPLES

### Example 1

20 g of pullulan (PI-20, Hayashibara) was dissolved in a mixture of 80 g of deionized (DI) water containing 2 g of glycerol. To this was added 16 grams of a 25% sucralose solution. All this was well mixed to a homogenous viscous fluid. This fluid was cast on a Mylar sheet using a drawdown bar set to a height of 500 microns and allowed to dry overnight at 70° F. and 50% relative humidity (RH). The dried film was then removed from the Mylar and cut with scissors into 22 mm×30 mm rectangular strips. The dried film, 2.2 mil thick, contained about 5% water by weight, so each 42 mg film strip contained about 6.13 mg sucralose. The final film was slightly brittle and slightly sticky to the touch, but dissolved well and gave the expected level of sweetness (i.e., 1 tsp of sugar per strip) when used to sweeten a cup of hot coffee.

### Example 2

20 g of pullulan (PI-20, Hayashibara) was dissolved in 80 g of DI water. To this was added 16 grams of a 25% sucralose solution. All this was well mixed to a homogenous viscous fluid. This fluid was cast on a Mylar sheet using a drawdown bar set to a height of 500 microns and allowed to dry overnight at 70° F. and 50% RH. The dried film was then removed from the Mylar and cut with scissors into 22 mm×30 mm rectangular strips. The dried film, 2.4 mil thick, contained about 5% water by weight, so each 42 mg film strip contained about 6.13 mg sucralose. The final film was less brittle and less sticky to the touch compared to Example 1. It dissolved well and gave the expected level of sweetness when used to sweeten a cup of hot coffee.

### Example 3

20 g of pullulan (PI-20, Hayashibara) and 1 gram of pectin (Unipectine PG 225 S) was dissolved in 80 g of DI water. To this was added 16 grams of a 25% sucralose solution. All this was well mixed to a homogenous viscous fluid. This fluid was cast on a Mylar sheet using a drawdown bar set to a height of 500 microns and allowed to dry overnight at 70° F. and 50% RH. The dried film was then removed from the Mylar and cut with scissors into 22 mm×30 mm rectangular strips. The dried film, 2.1 mil thick, contained about 5% water by weight, so each 42 mg film strip contained about 6.13 mg sucralose. The final film was neither brittle nor sticky to the touch, but dissolved well and gave the expected level of sweetness when used to sweeten a cup of hot coffee.

### Example 4

20 g of pullulan (PI-20, Hayashibara) and 1 gram of pectin (Genu® Pectin, Hercules) was dissolved in 80 g of DI water. To this was added 16 grams of a 25% sucralose solution. All this was well mixed to a homogenous viscous fluid. This fluid was cast on a Mylar sheet using a drawdown bar set to a height of 500 microns and allowed to dry overnight at 70° F. and 50% RH. The dried film was then removed from the Mylar and cut with scissors into 22 mm×30 mm rectangular strips. The dried film, 2.2 mil thick, contained about 5% water by weight, so each 42 mg film strip contained about 6.13 mg sucralose. The final film was slightly brittle and slightly sticky to the touch, quite similar to the film of Example 1. It dissolved well and gave the expected level of sweetness when used to sweeten a cup of hot coffee.

The films described in the previous examples were tested for their tensile strength and elongation to break according to procedure similar to ASTM D-882. The results from these tests are shown below:

| | Film | | | | Tensile | |
|---|---|---|---|---|---|---|
| Cast | Thickness | Gram | Force | | Strength | Percent |
| Number | (mil) | Force | CV | Modulus | Kg/sqcm | Elongation |
| Example 1 | 2.2 | 291 | 9% | 1.7 | 34 | 0.8 |
| Example 2 | 2.4 | 857 | 18% | 3.5 | 101 | 1.7 |
| Example 3 | 2.1 | 1,304 | 12% | 3.8 | 153 | 2.5 |
| Example 4 | 2.2 | 595 | 6% | 2.9 | 70 | 1.0 |

The preceding description of certain embodiments of the invention is not intended to be an exhaustive list of all possible embodiments. Persons skilled in this field will appreciate that modifications could be made to the specific embodiments described herein which would be within the scope of the following claims.

What is claimed is:

1. An edible film, comprising a major amount of pullulan and at least one sweetener in an amount of at least about 10% by weight on a dry solids basis.

2. The film of claim 1, wherein the at least one sweetener is a high intensity sweetener.

3. The film of claim 2, wherein the high intensity sweetener is sucralose, aspartame, acesulfame K, brazzein, or a combination of two or more thereof.

4. The film of claim 2, wherein the at least one sweetener consists essentially of sucralose.

5. The film of claim 2, wherein the amount of high intensity sweetener that is present in the film is selected to provide approximately the same sweetening effect as a selected quantity of sucrose.

6. The film of claim 1, wherein pullulan makes up greater than 50% by weight of film on a dry solids basis.

7. The film of claim 6, wherein pullulan makes up greater than 75% by weight of film on a dry solids basis.

8. The film of claim 1, further comprising at least one plasticizer.

9. The film of claim 8, wherein the at least one plasticizer is selected from glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations thereof.

10. The film of claim 1, further comprising at least one film-forming polymer in addition to pullulan.

11. The film of claim 10, wherein the at least one film-forming polymer is selected from pectin, alginates, carrageenans, xanthan gum, modified cellulose, polydextrose, starch, dextrin, maltodextrin, and combinations thereof.

12. The film of claim 1, further comprising gelatin.

13. The film of claim 1, further comprising a food grade wax emulsion.

14. A sweetener dispenser, comprising:
a container having an inner compartment and an aperture that is adapted to be opened; and
a plurality of film strips in the inner compartment, each of the film strips comprising a major amount of pullulan and at least one sweetener in an amount of at least about 10% by weight on a dry solids basis;
wherein individual film strips can be removed from the container through the aperture.

15. The dispenser of claim 14, wherein the at least one sweetener is a high intensity sweetener.

16. The dispenser of claim 15, wherein the high intensity sweetener is sucralose, aspartame, acesulfame K, brazzein, or a combination of two or more thereof.

17. The dispenser of claim 15, wherein the at least one sweetener consists essentially of sucralose.

18. The dispenser of claim 15, wherein the amount of high intensity sweetener that is present in the film is selected to provide approximately the same sweetening effect as a selected quantity of sucrose.

19. The dispenser of claim 14, wherein pullulan makes up greater than 50% by weight of film on a dry solids basis.

20. The dispenser of claim 19, wherein pullulan makes up greater than 75% by weight of film on a dry solids basis.

21. The dispenser of claim 14, wherein the film further comprises at least one plasticizer.

22. The dispenser of claim 21, wherein the at least one plasticizer is selected from glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations thereof.

23. The dispenser of claim 14, wherein the film further comprises at least one film-forming polymer in addition to pullulan.

24. The dispenser of claim 23, wherein the at least one film-forming polymer is selected from pectin, alginates, carrageenans, xanthan gum, modified cellulose, polydextrose, starch, dextrin, maltodextrin, and combinations thereof.

25. The dispenser of claim 14, wherein the film further comprises gelatin.

26. The dispenser of claim 14, wherein the film further comprises a food grade wax emulsion.

27. A method for sweetening a food, comprising:
providing a sweetener dispenser that comprises (a) a container having an inner compartment and an aperture that is adapted to be opened and (b) a plurality of film strips in the inner compartment, each of the film strips comprising a major amount of pullulan and at least one sweetener in an amount of at least about 10% by weight on a dry solids basis, wherein individual film strips can be removed from the container through the aperture;
removing at least one film strip from the dispenser; and
placing the at least one film strip in or on a food.

28. The method of claim 27, wherein the at least one sweetener is a high intensity sweetener.

29. The method of claim 28, wherein the high intensity sweetener is sucralose, aspartame, acesulfame K, brazzein, or a combination of two or more thereof.

30. The method of claim 28, wherein the at least one sweetener consists essentially of sucralose.

31. The method of claim 28, wherein the amount of high intensity sweetener that is present in the film is selected to provide approximately the same sweetening effect as a selected quantity of sucrose.

32. The method of claim 27, wherein pullulan makes up greater than 50% by weight of film on a dry solids basis.

33. The method of claim 27, wherein pullulan makes up greater than 75% by weight of film on a dry solids basis.

34. The method of claim 27, wherein the film further comprises at least one plasticizer.

35. The method of claim 27, wherein the at least one plasticizer is selected from glycerol, sorbitol, propylene glycol, polyethylene glycol, corn syrup, high fructose corn syrup, fructose, fruit juice, sucrose, maltodextrin, corn syrup solids, polydextrose, soluble fiber, and combinations thereof.

36. The method of claim 27, wherein the film further comprises at least one film-forming polymer in addition to pullulan.

37. The method of claim 36, wherein the at least one film-forming polymer is selected from pectin, alginates, carrageenans, xanthan gum, modified cellulose, polydextrose, starch, dextrin, maltodextrin, and combinations thereof.

38. The method of claim 27, wherein the film further comprises gelatin.

39. The method of claim 27, wherein the film further comprises a food grade wax emulsion.
